(19) United States
(12) Patent Application Publication
(10) Pub. No.: US 2011/0054103 A1
(43) Pub. Date: Mar. 3, 2011

(54) Fast Heat-up Thermoplastic Polymer Composition and Preparation Thereof

(75) Inventors: Ching-Tsu Peng, Hsinchu (TW); Chun-Wei Chen, Hsinchu (TW); Yui-Chi Lin, Hsinchu (TW)

(73) Assignee: ORIENTAL RESOURCES DEVELOPMENT LTD., Taipei (TW)

(21) Appl. No.: 12/547,569

(22) Filed: Aug. 26, 2009

(51) Int. Cl. C08K 3/08

(52) U.S. Cl. 524/440; 524/441; 524/439

(57) ABSTRACT

Disclosed herein is a thermoplastic polymer composition which has the beneficial combination of improved heat-up rates, high clarity, and low haze. Bottles are made from the bottle preforms by reheating the bottle preforms, wherein the bottle preforms include metal additives, and the blow moulding bottles from the reheated preforms.

### BACKGROUND OF THE INVENTION

1. Field of the Invention

The present invention is generally related to theremoplastic polymer composition, and more particularly to thermoplastic polymer composition and preparation thereof wherein the thermoplastic polymer composition can be employed to fabricate almost achromatic bottle and the bottle preform made of mentioned thermoplastic polymer composition can be fast heat-up before blowing.

2. Description of the Prior Art

Thermoplastic polymer, especially polyethylene terephthalate (PET) or PET co-polymer, is well known to be used on fabricating films, bottles, or other containers for food or drink. Generally, bottle manufacturing comprises two stages. Taking PET bottle manufacturing as example, the first stage is injecting PET into a mold for forming bottle preform, and the second stage is injecting compressed air into the mold for blowing the bottle preform to bottle. In the second stage, the bottle preform should be heated to about 100° C. for blowing, so that the reheating rate becomes the rate-determining step of the second stage. Commercially, quartz tube is used for the mentioned reheating, and the wave-length of electromagnetic wave from the quartz tube is mostly between 500 nm to 2000 nm.

However, the absorption of electromagnetic wave for PET is not good in the mentioned wave-length range. Mostly, the electromagnetic wave during reheating is absorbed by impurities or additives in bottle preform, such as catalyst residues or other impurities. It means that the bottle preform can majorly absorb the electromagnetic wave from the quartz tube by the impurities or additives. Therefore, reheating time is highly related to the composition of the bottle perform. When PET composition includes more impurities or additives, the reheating rate becomes faster, and the haze of the bottle preform is increased. Moreover, if the color of the additives is deeper, the electromagnetic wave absorbing ability of the bottle preform is better, and the reheating time of the bottle preform is shorter. Cause of employing additives with deep color in the bottle preform, the produced bottle will not be transparent and achromatic. The mentioned bottle cannot be satisfied in the recently commercial requirement, especially for Asia marketing requirement, on achromatic bottle or other containers.

There are many patents disclosed how to increase electromagnetic radiation absorption and decrease reheating time by employing additives in thermoplastic polymer composition. For instance, in U.S. Pat. No. 4,408,004, carbon black is employed as additives for decreasing reheating time. Some iron oxide also can approach the mentioned purpose, such as Fe₂O₃ disclosed in U.S. Pat. No. 4,420,581. In U.S. Pat. No. 5,419,936, reducing antimony trioxide into antimony metal is used to increase reheating rate. Some anthraquinone based dyes are mentioned in U.S. Pat. No. 4,481,314 for the mentioned purpose. In U.S. Pat. No. 6,660,792, some iron compounds that will not participate in the reaction, such as FeP, FeSi, or their combination, are used to decrease reheating time. U.S. Pat. No. 7,189,777 disclosed that activated carbon is employed for increasing reheating rate. All the mentioned additives are blackbody or graybody absorption, and the additives will absorb full spectrum wave. The blackbody absorption or graybody absorption of the additives will cause that the product formed thereof, such as bottles or other type container, becomes un-acceptable on the product color and haze. The more the additives is added, the more un-acceptable influence is caused. In some cases, the mentioned influence can be decreased by modifying the particle size of the additives. But, the mentioned cannot be completely avoided by modifying particle size.

Besides, U.S. Pat. No. 5,529,744 disclosed a bottle made of thermoplastic polymer including metal particles, such as Sb, Sn, Ag, Au, Cu, As, Cd, Hg, Pt, and/or Pd. In this mentioned patent, reducing agent and the compounds with the mentioned metals are added in polymerized process, and the metal compounds are reduced into metal particles, especially Sb, to increase the reheating rate of the polymers. But, according to this US patent, the absolute yellowness of the bottle or other type container produced from the polymer is too large to obtain achromatic product.

Though all the mentioned additives can increase reheating time of bottle preform, save energy, and improve manufacturing performance, the commercial requirement of achromatic containers still cannot be satisfied through those mentioned additives. Therefore, it is important to provide a thermoplastic polymer composition that can not only be fast heat-up during manufacturing but also produce almost achromatic product.

### SUMMARY OF THE INVENTION

According to the above, the present invention provides new thermoplastic polymer composition and preparation thereof to fulfill the requirements of this industry.

One object of the present invention is to add conductive material in proper amount into thermoplastic polymer composition to increase the thermo-conduction thereof, so that the heating rate of the preform will be improved.

Another object of the present invention is to employ thermo-plastic polymer composition with well-dispersed metal particles in proper amount, thus the preform made of the thermo-plastic polymer composition is fast heat-up and the product made of the preform is almost achromatic.

Still another object of the present invention is provide a fast heat-up thermoplastic polymer composition, the mentioned fast heat-up thermoplastic polymer composition comprises thermoplastic polymer and a plurality of metal particles, wherein the number average molecular weight (Mn) of the thermoplastic polymer is between 1,000 to 60,000, and the metal particle is selected from aluminum (Al), magnesium (Mg), zinc (Zn), tungsten (W), calcium (Ca), or the composition thereof. Upon the manufacturing necessary, mentioned fast heat-up thermoplastic polymer composition according to this invention can be made as melt, pellet, sheet, or container, especially properly for bottle preform and bottle.

Still another object of the present invention is provide a method of manufacturing fast heat-up thermoplastic polymer composition, the mentioned method comprises the following procedure: adding metal particles into thermoplastic polymer during one stage selected from the following: slurry stage, esterfication stage, melt state polycondensation stage, any other post-polymerization melt process, or forming stage

According to above-mentioned objectives, the fast heat-up thermo-plastic polymer composition of present invention comprises thermo-conductive metal particles, so that the heating rate can be efficiently increased, and the reheating time before processing, such as blowing, can be reduced. Besides, because the selection of the metal particles have been thought about the final coloring and transparency of the metal particle dispersion in the thermoplastic polymer, the product, such as bottle, made of the thermoplastic polymer composition can be fabricated in almost achromatic through properly controlling the adding amount and the particle size of the metal particles. Therefore, the thermoplastic polymer composition and preparation thereof according to this invention can achieve the requirement of markets, especially for Asia.

### DESCRIPTION OF THE PREFERRED EMBODIMENTS

What is probed into the invention is fast heat-up thermoplastic polymer composition and preparation thereof. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

One preferred embodiment of this present invention discloses a fast heat-up thermoplastic polymer composition. The mentioned fast heat-up thermoplastic polymer composition comprises a thermoplastic polymer, and metal particles. In one example of this embodiment, the thermoplastic polymer is polyester composed of a repeat unit A of di-acid based derivatives and a repeat unit B of diol based derivatives. The mentioned di-acid based derivatives comprises C₂˜C₁₆ aliphatic di-carboxylic acid, C₈˜C₁₆ aromatic di-carboxylic acid, or the composition thereof. Selectively, the di-acid derivatives comprises at least one C₈˜C₁₆ aromatic di-carboxylic acid. Preferably, the C₈˜C₁₆ aromatic di-carboxylic acid is terephthalic acid. In one preferred example, the thermoplastic polymer is polyethylene terephthalate (PET), or co-polyester with polyethylene terephthalate. When counting as the total mole of the di-acid based derivatives, terephthalic acid is at least 60 mol % of the di-acid based derivatives. When counting as the total mole of the diol based derivatives, ethylene glycol is at least 60 mol % of the diol based derivatives.

Selectively, in another example of this embodiment, the mentioned di-acid based derivatives comprises two C₈˜C₁₆ aromatic di-carboxylic acids. These two C₈˜C₁₆ aromatic di-carboxylic acids separately are terephthalic acid and isophthalic acid. Preferably, the di-acid based derivatives comprises 96˜99 mol % terephthalic acid, and 4˜1 mol % isophthalic acid.

Selectively, in another example of this embodiment, the mentioned diol based derivatives comprises at least one C₂˜C₁₀ diol. Preferably, the mentioned diol based derivatives comprises at least one C₂˜C₅ diol. In another example of this embodiment, the diol based derivatives comprises ethylene glycol. During the polymerization, part of ethylene glycol will be dehydrating and di-ethylene glycol (DEG) is formed thereof, so that the repeat unit B derived from di-ethylene glycol will exist in the co-polyester of the polymer product. Preferably, in the polyester product, when counting as the total mole of the repeat unit B, the repeat unit derived from ethylene glycol is 95˜99 mol %, and the repeat unit derived from di-ethylene glycol is 5˜1 mol %.

According to this embodiment, the metal particle is selected from aluminum (Al), magnesium (Mg), zinc (Zn), tungsten (W), calcium (Ca), or the composition thereof. In one preferred example, the metal particles are Al particles. Preferably, in the thermoplastic polymer composition of this embodiment, when counting as the total weight of the thermoplastic polymer, the metal particles are from 1 PPM to 200 PPM. More preferably, the metal particles are from 1 PPM to 100 PPM of the thermoplastic polymer. More preferably, the metal particles are from 20 PPM to 100 PPM of the thermoplastic polymer. Most preferably, the metal particles are from 25 PPM to 100 PPM of the thermoplastic polymer.

The particle size d₅₀ of the mentioned metal particles is from 0.1 to 100 μm. Preferably, the particle size d₅₀ of the mentioned metal particles is from 0.1 to 50 μm. More preferably, the particle size d₅₀ of the mentioned metal particles is from 0.1 to 10 μm. Most preferably, the particle size d₅₀ of the mentioned metal particles is from 0.1 to 5 μm.

Because the metal particles can be added in every polymerizing stage of thermoplastic polymer, the molecular weight of the thermoplastic polymer in the composition of this embodiment contains the degree of polymerization range in melt state polycondensation stage is usually about 10˜100 and in solid state polymerization it is usually about 100˜400. That is, the number average molecular weight (Mn) of the thermoplastic polymer according to this embodiment is about 1,000˜60,000. Selectively, the number average molecular weight (Mn) of the thermoplastic polymer is about 1,000˜45,000. Further selectively, the number of average molecular weight (Mn) the thermoplastic polymer is about 1,000˜35,000. In one preferred example of this invention, the number average molecular weight (Mn) of the thermoplastic polymer in each polymerizing stage is separately 1,350, 19,000, and 31,000.

The thermoplastic polymer composition of this embodiment can be used to fabricate melt, pellet, sheet, or container. In one preferred example, the thermoplastic polymer composition according to this embodiment is suitable for bottle preform and bottle manufacturing.

In one preferred example, a bottle preform made of the thermoplastic polymer composition according to this invention is disclosed. Preferably, the mentioned bottle preform is with brightness L* between 75% and 100%, and with haze from 2˜8.1. More preferably, the bottle preform is with brightness L* between 80% and 100%, and with haze from 2˜3.5. Preferably, the mentioned bottle preform is with a* between −3 and +3. More preferably, the mentioned bottle preform is with a* between −2 and +2. More preferably, a* of the mentioned bottle preform is about −2 to 0. Preferably, the mentioned bottle preform is with b* between −5 and +7. More preferably, the mentioned bottle preform is with b* between −5 and +5. More preferably, the b* of the mentioned bottle preform is about 0 to +5. In one preferred example of this embodiment, the produced bottle preform is with haze between 3.5 and 8.1, a* between −1.36 to −1.42, and b* between 4.73 and 4.98.

In another preferred example, a bottle made of the thermoplastic polymer composition according to this invention is disclosed. Preferably, the mentioned bottle is with brightness L* between 88% and 100%, and with haze from 1˜4. Preferably, the mentioned bottle is with a* between −1 and +1. Preferably, the mentioned bottle is with a* between −0.5 and +0.5. More preferably, the mentioned bottle is with a* between −0.5 and 0. Preferably, the mentioned bottle is with b* between −3 and +5. More preferably, the mentioned bottle is with b* between −1 and +4. More preferably, the b* of the mentioned bottle is about 0 to +3. In one preferred example of this embodiment, the produced bottle is with haze between 2.1 and 4, a* between −0.36 to −0.47, and b* between 2.41 and 2.59 (almost achromatic).

In this specification, the value of L*, a*, and b* are detected by Macbeth color eye 2145 spectrometer with 1976 CIE L* a* b* color presentation. In the detection, the ovserving angel is 2°, and the light source is D65. When the detected sample is bottle preform, the sample thickness is set as 4 mm. When the detected sample is bottle, the sample thickness is set as 0.35 mm. About the detecting result, the value of L* is larger means that the brightness of the sample is higher. That a*>0 means that the color of the sample is close to red, and a*<0 means that the color of the sample is close to green. That b*>0 means that the color of the sample is close to yellow, and b*<0 means that the color of the sample is close to blue. The haze of the sample is detected with a HAZE SUGA instrument by ASTM-D1003 method.

Another embodiment of this invention discloses a method for preparing fast heat-up thermoplastic polymer composition. The mentioned method for preparing fast heat-up thermoplastic polymer composition comprises the following step: adding metal particles into thermoplastic polymer during stage selected from the following: slurry stage, esterfication stage, melt state polycondensation stage and any other post-polymerization melt process, or forming stage. In one preferred example of this embodiment, the metal particles are added into the thermoplastic polymer during the melt sate polycondensation stage. In another preferred example of this embodiment, the addition of the metal particles into the thermoplastic polymer can be performed in once or multiple stages. In another preferred example of this embodiment, according to the requirement of the manufacture, the metal particles can be dispersed into a liquid medium before adding into the mentioned polymerization or forming stage. Preferably, the liquid medium is ethylene glycol.

Moreover, if the metal particles are added in the forming stage, such as during injecting the bottle preform, the metal particles are preferably dried before added. Besides, in order to decrease the pollution of the process line, the metal particles can be well-mixed with part of the polymer pellet by estrusion operation to form “masterbatch”, and then the masterbatch is employed in the production line in a large number.

The preferred examples of thermoplastic polymer composition and the preparation thereof according to the application are described in the following. However, the scope of this application should be based on the claims, but is not restricted by the following examples.

### General Detection:

Unless additional description, all the detection are going through with the following methods under normal temperature and normal atmosphere.

1. Intrinsic Viscosity measurement: dissolving 0.1 g sample into 25 cc solvent, wherein the solvent includes phenol and CCl₄ in volume ratio 3:2, and then measuring the solution with Ubbelohde viscosity meter at 30° C.

2. L*, a*, and b*: measured by Macbeth color eye 2145 spectrometer with 1976 CIE L* a* b* color presentation, the operating parameter and the meaning of L*, a*, and b* are as the above-mentioned description.

3. Haze: measured with a HAZE SUGA instrument by method ASTM-D1003.

4. “Percent Reheat improvement” is calculated as following:

% Reheat improvement=(bottle preform surface temperature of comparison example−bottle preform surface temperature of example)/(bottle preform surface temperature of example)×100%

### EXAMPLE 1

### Liquid Polymerization Stage

38 Kg terephthalic acid (TPA), 0.9 Kg isophthalic acid (IPA), and 18.16 Kg ethylene glycol (EG) with 1.125 g aluminum particles (d₅₀ is 2±1 μm) are added into a stirring tank, and the mixture is stirred to become a paste. The paste is poured into an esterification tank, and the temperature of the esterification tank is raised with an end temperature at 250° C. for 6.5 hours for processing esterification. When over 95% the esterification degree, a polymer product is obtained wherein the polymer product is polyester with polymerization degree about 7, and the number of average of molecular weight is about 1350. The polymer product is transferred to a polymerization tank, and 1260 g catalyst (Sb₂O₃) and 35 PPM anti-oxidant (H₃PO₄) are added into the polymerization tank. The polymerization tank is heated and vacuumed until the intrinsic viscosity of the mixture is about 0.6 dL/g (number of average of molecular weight is about 19000). After executing cutting, PET melt state polycondensation co-polyester pellet doped with aluminum particles is obtained. The added amount of the aluminum particles is 25 PPM based on PET weight.

### Solid Phase Polymerization

After pouring the melt state polycondensation pellet into a solid phase polymerizing tank, the temperature of the mentioned tank is raised to 85° C. for drying for 2.5 hours. Then, the temperature of the tank is raised to 105° C. for drying for 3 hours. Subsequently, the temperature of the tank is raised to 150° C. for pre-crystallizing for 2 hours. Then, the temperature of the tank is raised to 235° C. until the intrinsic viscosity of the mixture is about 0.85 dL/g (number of average of molecular weight is about 31,000). After cutting, PET solid state polymerization co-polyester pellet doped with aluminum particles is obtained.

Because EG is overdosed and part of EG are dehydrated to form DEG during polymerization, the repeat unit of the PET co-polyester from solid state polymerization can be identified through calculating the added amount of TPA and IPA, wherein the added TPA and IPA are totally reacted, and employing GC (Perkin Elmer auto system) to measuring the DEG amount in the co-polyester. In the PET co-polyester, based on the total mole of the repeat unit A, the repeat unit A derived from TPA and IPA are separately 97.7 mol % and 2.3 mol %. Based on the total mole of the repeat unit B, the repeat unit B derived from EG and DEG are separately 97.6 mol % and 2.4 mol %.

### Bottle Preform Injection

Solid state polymerization polyester pellet is dried under 160° C. for 5 hours, and then poured into an injecting machine manufactured by Jonwai Machinery Works Corp. Ltd. Through the injecting machine, bottle preform is injected at 275° C.˜280° C.

### Bottle Blowing Stage

The injected bottle preform is put into a blowing machine made by CHIA MING Machinery Co., Ltd., heated at 105° C. by quartz tube for 50 seconds, and then an infrared temperature sensor is employed to measure the surface temperature of the bottle preform.

The measured surface temperature data of the bottle preform is shown as Table 1. Subsequently, the heat-softened bottle preform is put into blowing mold, and blown to form bottle by nitrogen at 18˜32 Kg/cm³. The measured physical data of the bottle preform and the bottle is shown as Table 1 and Table 2.

### EXAMPLE 2

Except adding 50 PPM Aluminum powder in the melt state polycondensation stage, in this example, all the condition is just as the Example 1. After solid state polymerization, the repeat unit of the PET co-polyester pellet of this Example is the same as that of Example 1. The measured data of the bottle preform and the bottle of this example is shown as Table 1 and Table 2.

### EXAMPLE 3

Except adding 100 PPM Aluminum powder in the melt state polycondensation stage, in this example, all the condition is just as the Example 1. After solid state polymerization, the repeat unit of the PET co-polyester pellet of this Example is the same as that of Example 1. The measured data of the bottle preform and the bottle of this example is shown as Table 1 and Table 2.

### EXAMPLE 4

Except adding 25 PPM Aluminum powder (d₅₀ is 0.1±0.05 μm) in the melt state polycondensation stage, in this example, all the condition is just as the Example 1. After solid state polymerization, the repeat unit of the PET co-polyester pellet of this Example is the same as that of Example 1. The measured data of the bottle preform and the bottle of this example is shown as Table 1 and Table 2.

### COMPARISON EXAMPLE

Except not adding any Aluminum in the melt state polycondenssation stage, in this example, all the condition is just as the Example 1. After solid state polymerization, the repeat unit of the PET co-polyester pellet of this Example is the same as that of Example 1. The measured data of the bottle preform and the bottle of this example is shown as Table 1 and Table 2.

TABLE 1

| | Conc. of Al | | Surface | Reheat | | | | |
|---|---|---|---|---|---|---|---|---|
| bottle | powder | particle | temp. | Improv. | | | | |
| preform | (ppm) | size | (° C.) | (%) | Haze | L* | a* | b* |
| Comparison | 0 | 2 μm | 113 | 0 | 2.2 | 82.43 | −1.36 | 4.85 |
| example | | | | | | | | |
| Example 1 | 25 | 2 μm | 118 | 4.42 | 3.5 | 81.5 | −1.37 | 4.9 |
| Example 2 | 50 | 2 μm | 122 | 7.96 | 5.6 | 79.94 | −1.41 | 4.98 |
| Example 3 | 100 | 2 μm | 129 | 14.15 | 8.1 | 78.31 | −1.42 | 4.73 |
| Example 4 | 25 | 0.1 μm | 119 | 5.31 | 3.0 | 82.1 | −1.37 | 4.8 |

TABLE 2

| | Conc. | | | | | |
|---|---|---|---|---|---|---|
| | of Al | | | | | |
| | powder | particle | | | | |
| bottle | (ppm) | size | Haze | L* | a* | b* |
| Comparison | 0 | 2 μm | 1.0 | 89.81 | −0.36 | 2.90 |
| example | | | | | | |
| Example 1 | 25 | 2 μm | 2.1 | 90.94 | −0.47 | 2.41 |
| Example 2 | 50 | 2 μm | 3.6 | 90.50 | −0.46 | 2.41 |
| Example 3 | 100 | 2 μm | 4 | 89.71 | −0.46 | 2.59 |
| Example 4 | 25 | 0.1 μm | 1.5 | 90.82 | −0.45 | 2.54 |

According to the above Table 1 and Table 2, though the Haze of the bottle preforms from Example 2 and Example 3 are a little high, after blowing stage, all the bottles of comparison example and Example 1˜4 can achieve the commercial requirement range on brightness (L*˜90) and haze (Haze≦4). Besides, through comparing the bottle preform surface temperature, for those example doped with aluminum powder, the heating time of the bottle preform is efficiently shortened, and the produced bottles in the examples doped with aluminum powder are almost achromatic and transparent especially using smaller particle size of aluminum powder. Therefore, the bottle preform in the examples according to this invention can achieve higher surface temperature than those bottle preform without aluminum powder in the same heating time.

To sum up, this present application discloses a fast heat-up thermoplastic polymer composition and preparation thereof. Through adding metal particles with high thermal conductivity into the manufacturing stages, thermoplastic polymer composition according to this application is obtained. The mentioned thermoplastic polymer composition is not only fast heat-up in re-heating stage, especially in bottle preform re-heating stage, but also can be used to fabricate almost achromatic and transparent final product, especially to fabricate bottle, wherein the final product can satisfy the commercial requirement on achromatic container. In the prior art, thermoplastic polymer composition can be fast heat-up in the re-heating stage by adding black-body or gray-body absorption particles into the thermoplastic polymer, and then a final product can be formed thereof with color and without transparency. Therefore, this application provides an economic method to fabricate thermoplastic polymer product by employing fast heat-up thermoplastic polymer composition to save re-heating energy. Besides, the above-mentioned thermoplastic polymer composition according to this application is enough achromatic and transparent to satisfy commercial requirement on achromatic containers.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A fast heat-up thermoplastic polymer composition comprising:
a thermoplastic polymer with a number of average of molecular weight between 1,000 and 60,000; and
a plurality of metal particles, wherein the metal particles are selected from aluminum (Al), magnesium (Mg), zinc (Zn), tungsten (W), calcium (Ca), or the composition thereof.

2. The fast heat-up thermoplastic polymer composition according to claim 1, wherein said metal particles are Al particles.

3. The fast heat-up thermoplastic polymer composition according to claim 1, wherein the metal particles are from 1 PPM to 100 PPM by counting as the total weight of the thermoplastic polymer.

4. The fast heat-up thermoplastic polymer composition according to claim 1, wherein the d₅₀ particle size of said metal particles is from 0.1 to 100 μm.

5. The fast heat-up thermoplastic polymer composition according to claim 1, wherein said thermoplastic polymer a polyester composed of a repeat unit A of di-acid based derivatives and a repeat unit B of diol based derivatives.

6. The fast heat-up thermoplastic polymer composition according to claim 5, wherein said di-acid based derivatives comprises C₂˜C₁₆ aliphatic di-carboxylic acid, C₈˜C₁₆ aromatic di-carboxylic acid, or the composition thereof.

7. The fast heat-up thermoplastic polymer composition according to claim 6, wherein said C₈˜C₁₆ aromatic di-carboxylic acid is terephthalic acid.

8. The fast heat-up thermoplastic polymer composition according to claim 7, wherein said thermoplastic polymer is polyethylene terephthalate (PET), or co-polyester of polyethylene terephthalate.

9. The fast heat-up thermoplastic polymer composition according to claim 8, wherein terephthalic acid is at least 60 mol % of the di-acid based derivatives by counting as the total mole of the di-acid based derivatives, and ethylene glycol is at least 60 mol % of the diol based derivatives by counting as the total mole of the diol based derivatives.

10. The fast heat-up thermoplastic polymer composition according to claim 6, wherein said di-acid based derivatives comprises two C₈˜C₁₆ aromatic di-carboxylic acids.

11. The fast heat-up thermoplastic polymer composition according to claim 10, wherein said two C₈˜C₁₆ aromatic di-carboxylic acids separately are terephthalic acid and isophthalic acid.

12. The fast heat-up thermoplastic polymer composition according to claim 11, wherein said di-acid based derivatives comprises 96˜99 mol % terephthalic acid, and 4˜1 mol % isophthalic acid.

13. The fast heat-up thermoplastic polymer composition according to claim 5, wherein said diol based derivatives comprises at least one C₂˜C₁₀ diol.

14. The fast heat-up thermoplastic polymer composition according to claim 13, wherein said diol based derivatives comprises ethylene glycol.

15. The fast heat-up thermoplastic polymer composition according to claim 14, wherein said repeat unit derived from ethylene glycol is 95˜99 mol % by counting as the total mole of the repeat unit B, and the repeat unit derived from di-ethylene glycol is 5˜1 mol % by of the repeat unit B.

16. The fast heat-up thermoplastic polymer composition according to claim 1, wherein said fast heat-up thermoplastic polymer composition is used to fabricate melt, pellet, sheet, bottle preform, bottle or other kind of container.

17. The fast heat-up thermoplastic polymer composition according to claim 16, wherein said fast heat-up thermoplastic polymer composition is used to fabricate said bottle preform, wherein said bottle preform is with brightness L* between 75% and 100%, and with haze from 2 to 8.1.

18. The fast heat-up thermoplastic polymer composition according to claim 16, wherein said fast heat-up thermoplastic polymer composition is used to fabricate said bottle, wherein said bottle is with brightness L* between 88% and 100%, and with haze from 1 to 4.

19. The fast heat-up thermoplastic polymer composition according to claim 1, wherein the number average molecular weight (Mn) of said thermoplastic polymer is 1,000˜45,000.

20. A preparation for manufacturing a fast heat-up thermoplastic polymer composition, comprising:
adding metal particles into a thermoplastic polymer during one selected from the following: slurry stage, esterfication stage, polycondensation stage, any other post-polymerization melt process, or forming stage.

21. The preparation for manufacturing said fast heat-up thermoplastic polymer composition according to claim 20, wherein the metal particles are added during the melt state polycondensation stage of the thermoplastic polymer.
